(19) United States
(12) Patent Application Publication
(10) Pub. No.: US 2002/0169698 A1
(43) Pub. Date: Nov. 14, 2002

(54) WIP management warehouse system

(75) Inventor: Chih-Hung Chien, Tao-Yuan Hsien (TW)

Correspondence Address: MERCHANT & GOULD PC, P.O. BOX 2903, MINNEAPOLIS, MN, 55402-0903, US

(73) Assignee: Mitac International Corp., Hsinchu (TW)

(21) Appl. No.: 10/123,458

(22) Filed: Apr. 16, 2002

(30) Foreign Application Priority Data
May 8, 2001 (TW) 090110902

(51) Int. Cl. G06F 7/00; G06F 17/60

(52) U.S. Cl. 705/28; 700/214

(57) ABSTRACT

A WIP management warehouse is disclosed. It monitors and controls on-site materials in a warehouse center to avoid stocking materials for too long, and distributes materials to appropriate locators, thus simplifying the manufacturing process. The invention includes the steps of: establishing a stocking area, a picking area and a WIP management area; transferring materials in the stocking area to the picking area according to a WO for picking materials; transferring materials in the picking area to the WIP management area according to a KO for production; returning unused materials in the WIP management area to the picking area.

### BACKGROUND OF THE INVENTION

1. Field of the Invention

The invention relates to a warehouse system and, in particular, to a WIP (Work In Progress) management warehouse system that monitors and controls WIP materials.

2. Related Art

In light of economic growth in developing countries, evolution of global supply chain concepts, increasing economic and commercial exchange in all areas, progress in information and communication technologies, and loosening of global monetary and transportation controls, E-business will be the trend of future businesses. How to effectively control SCM (Supply Chain Management), provide high-quality and high-efficiency products for customers, while at the same time minimizing operation costs will be a key factor for an enterprise to stay internationally competitive in the global market.

In conventional material distribution systems, warehousing mainly plays the role of storage and maintenance. However, under the pressures of changing consumer needs, large amounts of complicated data, and market competition, input and output of materials in a warehouse system have become fast and complicated in order to satisfy the market demands for small quantities, wide variety, and time effectiveness. In addition, in various techniques of material distribution, using the ASRS (Automated Storage Retrieval System) is one of the best solutions. However, most of the ASRS's in Taiwan are used in ingredient warehouses or delivery warehouses in factories. The basic operation of the ASRS is very simple because there are not very many types of stored materials and most of them are stored, received, and shipped in large amounts. The material reception and shipping use the pallet as the basic unit. Therefore, in material delivery operations, there is no need to plan any picking mode for assistance. The function of the ASRS is mainly storage. Once the complete ASRS is installed in a material distribution center that requires small quantities, wide variety, high frequency and fast delivery speed, it is likely to have integration problems of generating storage functional interfaces and picking functional interfaces. As locator planning in the ASRS is the key to solving the above problems and also the main factor that affects storage retrieval machine moving time and use frequency, developing effective locator planning rules for the merchant's reference in making their ASRS and locator changing policies is an urgent problem at present.

Before introducing the disclosed system, let us review traditional warehouse systems and their drawbacks. Due to the limits of the previous system and to achieve the goal of a virtual hub, we also discuss in detail the reasons for improving the systems. According to their techniques, warehouse systems have three generations:

Early years: Fixed warehouse personnel manage fixed materials in fixed areas.

Drawbacks:

1. The system has to be manually updated for operation and maintenance conditions. Mistakes and time delays are likely to result.

2. Nobody knows where certain materials are stored if the assigned responsible person is on vacation.

3. Material picking requires that an employee is able to determine whether the picked materials are correct.

4. Material counting requires that an employee is able to determine whether the quantities of materials are correct.

5. One cannot know the stock conditions until all orders are manually input to the system at the end of the day.

6. It is impossible to control FIFO (First-In-First-Out).

7. It is impossible to figure out which material supplier a particular material comes from.

8. Material checking cannot be performed until the operation is stopped.

9. There is no reservation function.

Nowadays: Each locator is controlled. Materials can be randomly stored numbered locators for the system to generate a picking list.

Drawbacks: although some problems in the previous systems are solved, there are still the following problems:

1. Material picking still requires that an employee is able to determine whether the picked materials are correct.

2. Material counting still requires that an employee is able to determine whether the quantities of materials are correct.

3. One cannot know the stocking conditions until all orders are manually input to the system at the end of the day.

4. Material checking cannot be performed until the operation is stopped.

5. There is time delay in its reservation function.

As the modem economy has been globalized and E-business has become the trend, the material distribution function is increasingly important. The modem commerce center integrated with “material distribution, commerce distribution, monetary distribution and information distribution” will be the mainstream in the future. To welcome the global competition era, a complete warehouse system gradually becomes the key to success in business management. The warehouse system center is the crux of the material distribution industry. If decision efficiency can be improved, a business can maintain its competitive advantage.

### SUMMARY OF THE INVENTION

To solve the above problems, using bar code on-line operation along with an RF (Radio Frequency) device or a bar code machine, inventory data seen on a website is exactly the same as the actual inventory data, without any time delay. Through the control of bar codes, the invention can control the stocking conditions of each vendor owner.

It is thus highly desirable to provide a warehouse management model and to perform thorough bar code control using a warehouse management system. The in and out or moves in the warehouse center can be immediately updated in the inventory data through the RF device. This new management method can provide the following functions that conventional warehousing cannot achieve:

1. Cyclic material checking can be performed at any time without stopping any activities or order processing.

2. The RF device replaces paper works, resulting in paperless processing.

3. One can immediately know any information related to a bar code, such as its locator, material cartons, material boxes, and pallets, by simply scanning it.

4. Conventional management by the whole sum of materials is improved to management by boxes or packs.

5. The system can perform FIFO control.

6. Picking materials does not require freezing the moves of locators. The system can immediately update the data while boxes are being moved.

7. The time and amount of the in and out of a particular material and the operating personnel can be recorded in the system, achieving bin card management.

8. It is possible to compute the time period materials in each carton are not picked or moved. This information can be used to process materials with low usage rates.

The disclosed method includes the steps of establishing a stocking area, a material picking area and a management area for WIP (Work In Progress). Through a WO (Work Order), materials in the inventory are transferred to the material picking area for picking. A KO (Kit Order) is used to transfer materials in the material picking area to the management area for work in progress. Finally, unused materials in the management area for work in progress are returned to the material picking area.

### BRIEF DESCRIPTION OF THE DRAWINGS

The invention will become more fully understood from the detailed description given hereinbelow. However, this description is for purposes of illustration only, and thus is not limitative of the invention, wherein:

FIG. 1-a shows a hierarchical relation diagram of commodity picking defined by the disclosed warehouse management system;

FIG. 1-b shows a hierarchical relation diagram of orders of different formats defined by the disclosed warehouse management system;

FIG. 2 is a functional diagram of material distributing and picking according to the invention;

FIG. 3 is a structural diagram of the disclosed SFCS;

FIG. 4 is a control operation flowchart of the disclosed SFCS;

FIG. 5-a shows the relation between the stocking area and the KC of the invention;

FIG. 5-b shows the relation between the picking area and the management system for work in progress; and

FIG. 6 is a flowchart of the disclosed back flush operation.

### DETAILED DESCRIPTION OF THE INVENTION

The specification discloses a warehouse system with an optimal management procedure in response to BPR (Business Process Reengineer) and ERP (Enterprise Resource Planning) proposed recently. Its goal is to reengineer the work procedure of warehousing to increase production while lowering organization operation costs. The invention is implemented in a warehouse system so that the inventory management, locator transfers, material distributing operations, material picking operations and the SFCS (Shop Floor Control System) in the warehouse system automatically retrieve data using an automated data capture method. Various kinds of optical and electronic scanning devices or bar code machines are employed to read data. The obtained data are updated in the system in real-time, avoiding possible problems due to time delays.

A preferred embodiment is illustrated below to demonstrate explicitly how the disclosed method can be implemented. Through the warehouse management system, materials from different vendors are integrated and provided to the manager of assembly lines for easy management. Before a detailed explanation of the invention, let us first introduce the operation procedure of the invention and the picking method that defines a commodity hierarchy. Before the manufacturer ships any commodity, an ASN (Advance Shipping Notice) is first sent out. The BC (Bar Code) of each box of materials is scanned and the quantities are checked according to the ASN. The BC is used as an ID for each material. However, not all vendors can meet this requirement. In this case, those without an ASN will be provided with an ASN and any commodity without a BC will be given one. After scanning BC's, the system will sum up the quantities of different commodities according to the PO (Product Order) scanned. The scanned sum is then re-checked with the quantity indicated in a PL (Picking List).

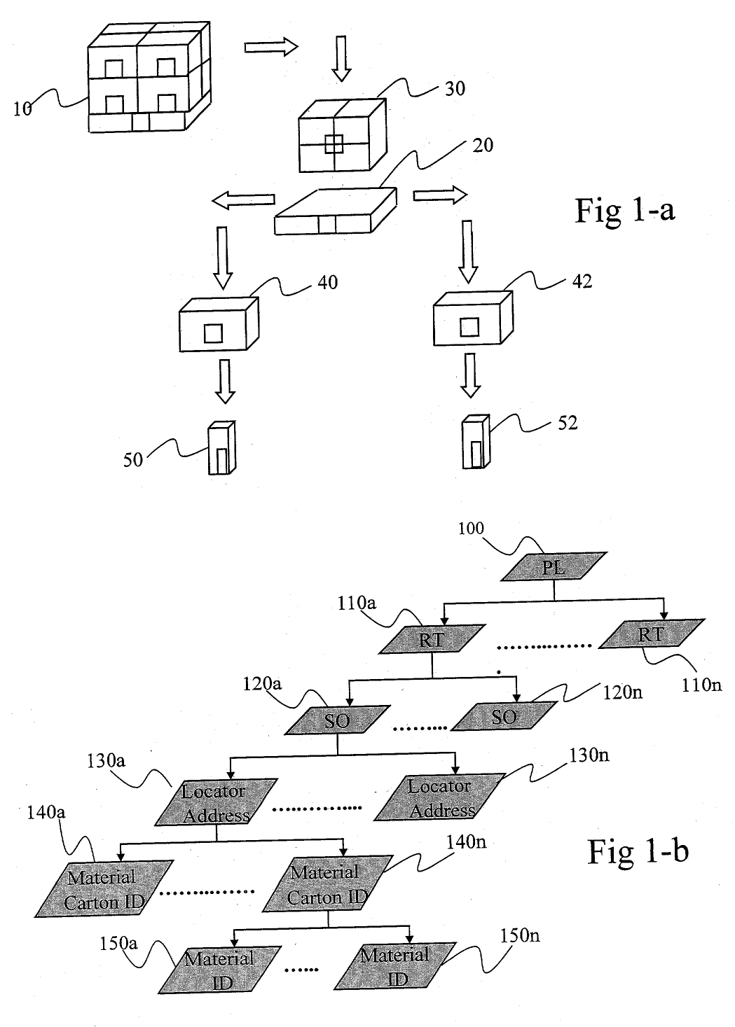

FIG. 1-a shows a hierarchical relation diagram of commodity picking defined by the disclosed warehouse management system. It is used to define picking units in storage. Analyzing the data levels provided by the vendor, the top level should be ASN or the so-called cargo 10. Below the cargo, there are several pallets 20. Each pallet 20 is disposed with a plurality of material cartons 30. Each material carton 30 contains materials of the same PO (Product Order) and the same type. Each material carton 30 has a plurality of material boxes 40 containing a plurality of material items 50. A BC (Bar Code) label is attached to each unit as its ID. The above-mentioned BC's are linked together to form the ASN or data that should be included a standard shipping list. The disclosed warehouse management system provides a bin card, which can convert the ID consisting of BC's into a text description so that operators can obtain information relevant to the material during operations.

The above-mentioned input data are obtained by scanning each BC using an RF (Radio Frequency) scanner. After a box of materials is shelved into the warehouse, the BC becomes the ID of the box. Data such as the locators in which the box has been placed, check-out quantities, persons who check them out, when the box arrived and which company the box belongs to are recorded on the ID for the warehouse management system to centralize its management.

With reference to FIG. 1-b, the hierarchical relation diagram is explained below. After counting all materials and scanning each BC, the RF scanner transmits the data to the warehouse management system in real-time. At that moment, the warehouse management system generates the hierarchical data as shown in FIG. 1-b. A plurality of RT's (Receiving Ticket) 110 is then generated from a PL (Picking List) 100. Within the same RT 110, we can further group material cartons 40 with the same capacity of material items 50 into an SO (Storing Order) 120. The SO 120 stores a plurality of locator addresses 130, through which one can find the needed material carton ID's 150 and material item ID 150 from the BC's.

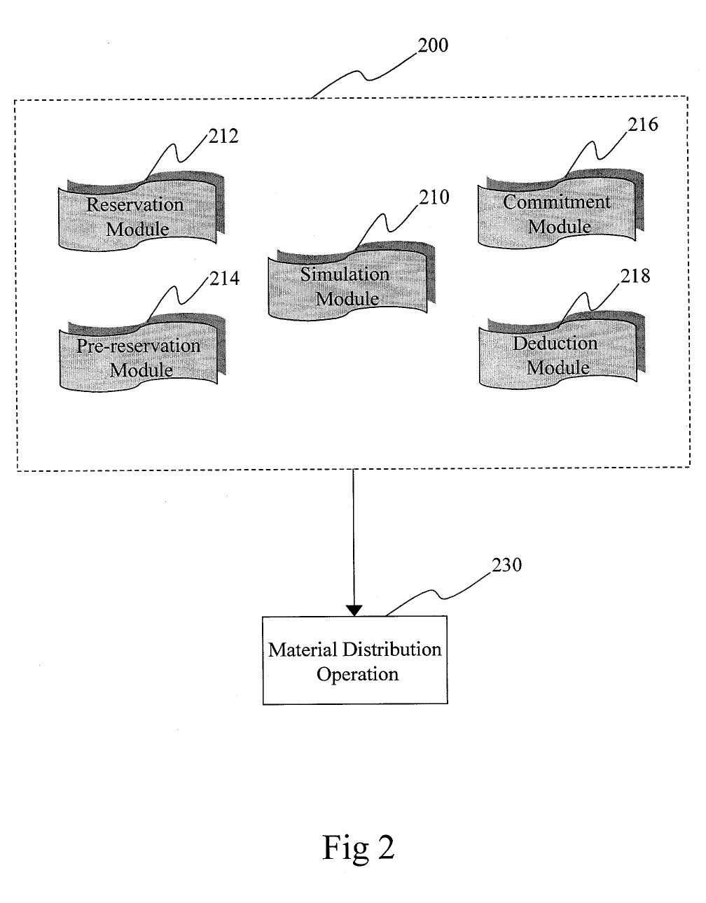

With the complete BC management in the warehouse, the in and out or transfers of materials are immediately updated in the inventory database through the RF scanner, achieving real-time operations. Material distribution is a very complicated operation because different production methods have different requirements in picking. With reference to FIG. 2, the warehouse management system provides a plurality of modules and a control mechanism for material distributing and picking operations. The warehouse management system 200 includes: a simulation module 210, a reservation module 212, a pre-reservation module 214, a commitment module 216, and a deduction module 218. The five modules are prepared for the material distributing operation 230. The goal is to solve the problems of normal material distributing operation.

The five modules are explained in detail as follows:

1. Simulation module 210: This module provides a simulation function, which prepares materials needed for assembly lines in the future according to a predetermined production schedule through the computation of the warehouse management system 200.

2. Reservation module 212: This module provides a reservation function, which reserves materials computed by the simulation module 210 so that the reserved materials will not be used by other units.

3. Pre-reservation module 214: This module provides a pre-reservation function. Since the reservation module 212 only reserves the total quantity of materials, but not individual cartons, materials may be insufficient due to material deterioration. At this point, the pre-reservation module 214 automatically determines material shortage and performs pre-reservation. Once materials in shortage are received, the warehouse management system 200 then directly reserves the materials.

4. Commitment module 216: This module provides a commitment function, which commits reserved materials to each carton of the materials for picking personnel to pick.

5. Deduction module 218: This module provides a deduction function, which deducts picked materials from the reserved materials.

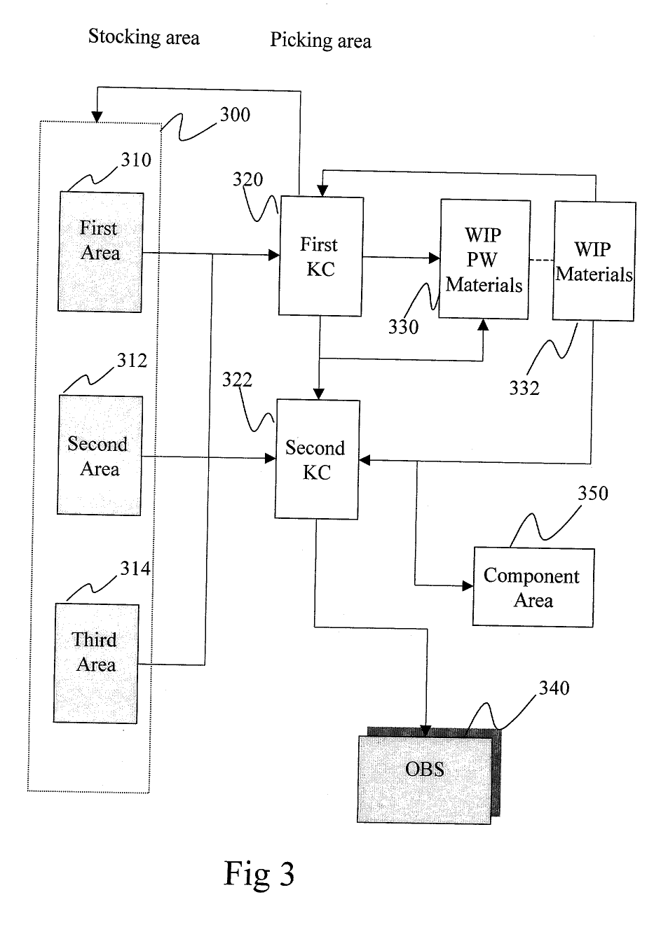

FIG. 3 shows the structure of the disclosed SFCS (Shop Floor Control System). In this system, the stocking area is divided according to the characters and sizes of materials into a UL (Unit Load), an ML (Mini Load), an SML (Small Mini Load), and an SR (Strong Room). From small to large, there is a first area 310, such as the SMT (Surface Mounting Technology), a second area 312, such as the hand-plugging area, and a third area 314, such as a system assembly area. The picking area can be divided according to the usage rate into a first KC (Kitting Center) 320 (such as a mother board KC) and a second KC 322 (such as an electronic KC). The assembly lines are also divided into WIP (Work In Progress) PW (Product Warehouse) materials 330, WIP materials 332, an OBS (Obsolescence) 340 and a component area 350.

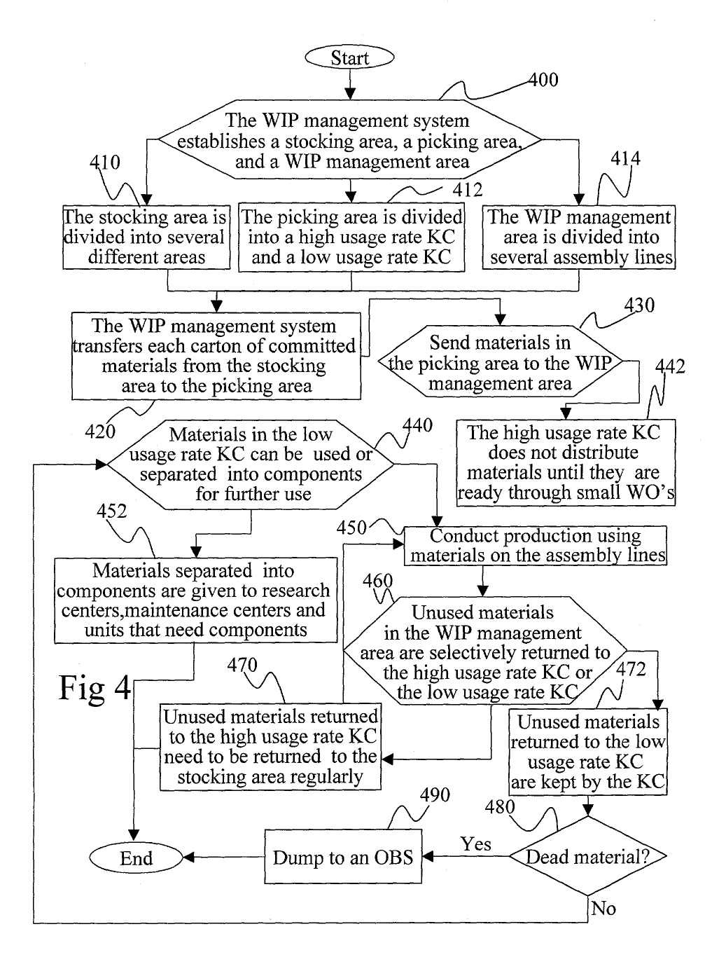

FIG. 4 is a control operation flowchart of the disclosed SFCS. In step 400, a stocking area, a picking area, and a WIP management area are established in the SFCS. Afterwards, the stocking area is divided into a plurality of different areas (step 410). The picking area is divided into a high usage rate KC and a low usage rate KC (step 412). The WIP management area is divided into a plurality of assembly lines (step 414). After the divisions are done, the SFCS can perform material picking, distributing and production. Through reservation via a WO (Work Order) and the demand in a client KO (Kit Order), the SFCS transfers each of the committed cartons of materials from the stocking area to the picking area (step 420). The materials in the picking area are then sent to the WIP management area (step 430). The materials can be sent from a high usage rate KC or a low usage rate KC. The materials stored in the low usage rate KC can be first used or separated into components (step 440). The materials with the highest priority for use can be immediately used for production (step 450). The materials separated into components are given to research centers, maintenance centers and units that need components (step 452). The high usage rate KC distributes materials only if all materials are ready through small WO's (step 400). In other words, the high usage rate KC does not distribute materials to the WIP management area until all materials needed in the WO are ready. Step 450 uses the materials on the assembly lines to make products. Unused materials in the WIP management area can be returned to the high usage rate KC or the low usage rate KC (step 460). The unused materials being returned to the high usage rate KC need to be put back to the stocking area regularly for future use (step 470). The unused materials being returned to the low usage rate KC are maintained by the KC (step 472). When unused materials are kept for too long, the system automatically determines whether they become dead materials (step 480). If they become dead materials, then they are returned to the OBS (step 490). If clients still need to use the unused materials, then step 440 follows to perform material usage and production in the low usage rate KC.

The above-mentioned high usage rate KC, such as a mother board KC 320, stores materials with high usage rates in order to save space. If any material has a slow flow rate, then it should be returned to the stocking area, preventing the KC from overstocking. The SMT area 310, the hand plugging area 312, and the system assembly area 314 have three different stocking areas to facilitate material distributing operations. The SR stores expensive materials such as CPU's and DRAM's. Therefore, it has a distinct material distributing operation and a person is assigned for material picking. When the system generates a PL for the SR, the assigned personnel can select the materials from the RF scanner and then use it to pick materials. Since the SR stores expensive materials, to avoid theft the material pallets and boxes are put away back to the SR after picking. They are moved to the locators for material distribution and to assembly lines only when the assigned personnel come to pick the materials.

The locator transfers usually come from the demand of organizing locators. The warehouse management system first searches locators that contains cartons less than a predetermined quantity and combines them to form a list of locators for transfers. According to the list, material cartons in the locators are moved from a UL to an ML or the materials left in the material cartons in an ML are combined into new material cartons and then moved to an SML.

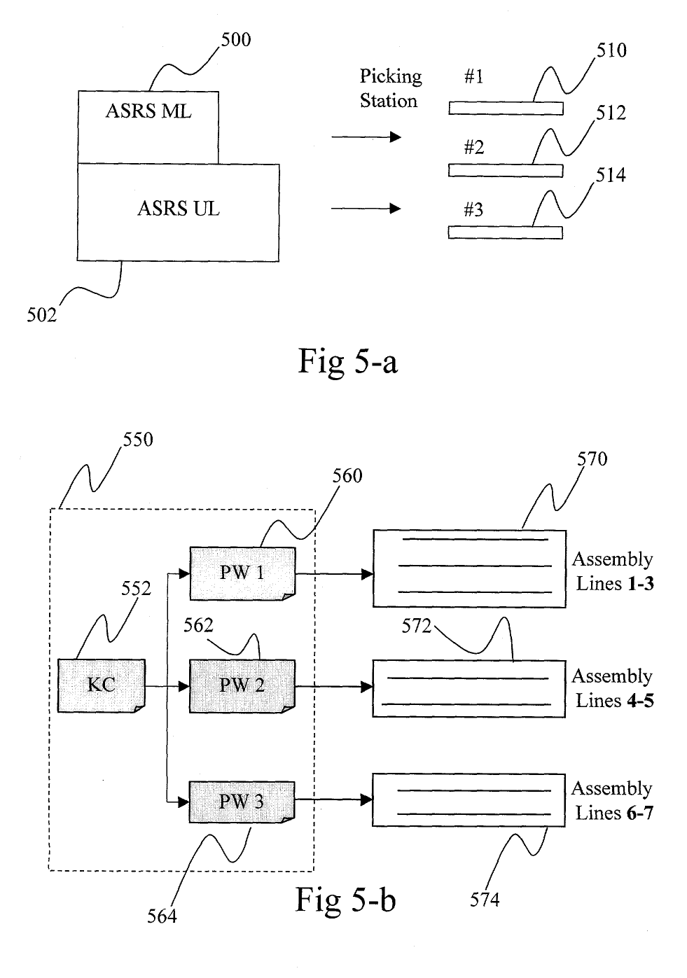

The warehouse management system further provides an SKC (System KC). However, since the sizes of system materials are too big to be picked online or stacked in the KC, several picking stations are designed to be set at ASRS (Automated Storage Retrieval System) outlets (see FIG. 5-a). FIG. 5-a shows the relation between the stocking area and the KC, and provides a preferred embodiment of the invention.

The ASRS sends materials to each picking station 510, 512 and 514 according to the different KO's (this process can be done using automated belts if space is available). Picking personnel at the picking stations then scans the BC's of material cartons 40 and determines quantities to pick. The rest of the materials are returned to the stocking area in ASRS ML 600. When the KO's are all processed, there should be no stocks in the SKC. The only problem of this method is that it is not convenient for small-quantity and high-frequency picking because the ASRS and picking stations may be overloaded. If this production type is needed, the motherboard KC can be used. Another problem is that if the same carton is simultaneously committed by two KO's, then one of them may not be able to get the materials in time. A further exception is the SR in the SKC. The SKC is divided into two types: one being locators of the picking stations and the other being the SR. Therefore, one KO of the warehouse management system generates two PL's (one for the picking stations and the other for the SR).

Thus, the ASRS UL and ML are divided into two areas. When there is one system KO committing, the warehouse management system will commit to the ID of each material carton. At the same time, the warehouse management system produces two KO's to get materials (in unit of cartons) from the UL and ML to the picking stations, respectively. When the material supply operation starts, the PL at the picking stations also starts picking operations. One PL corresponds to multiple KO's, and only one RF device is assigned to each KO to pick materials. Only one PL can be processed at a time.

The materials left over from the picking at the picking stations are returned along with the material cartons back to the ASRS ML by assigned personnel. For each picking station, the system assigns a locator ID. The material supply personnel (or picking personnel) determine which picking station to supply (or pick) materials.

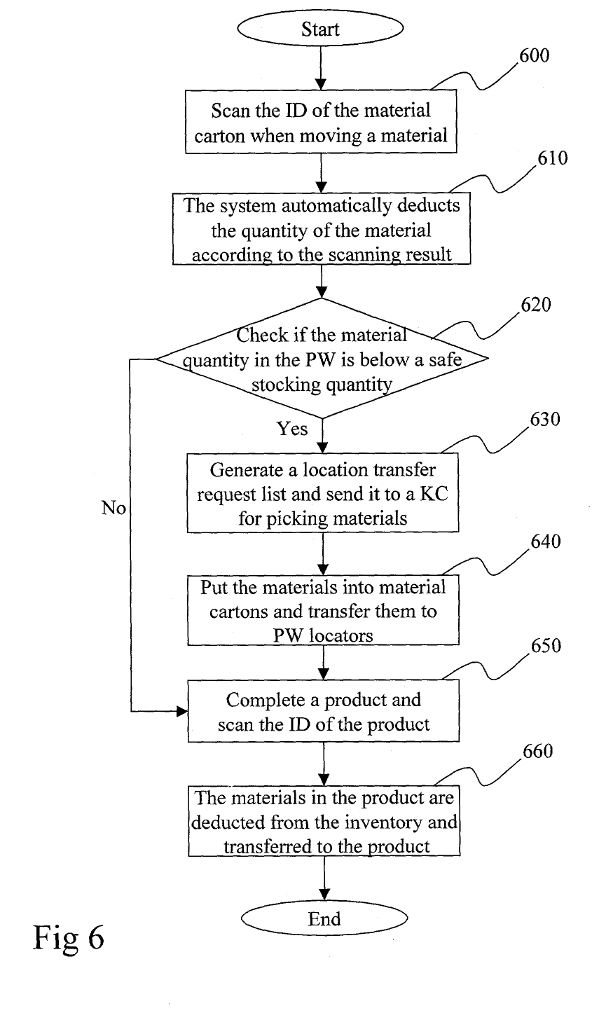

With reference to FIG. 5-b, in the KC 552 inside the picking area 550, materials are disposed in PW's (Product Warehouses) 560, 562 and 564. Each PW has a plurality of assembly lines 570, 572 and 574. The warehouse management system manages the PW's so that each assembly line has PW locators. WO's (Work Orders) are listed individually for each of the assembly lines. Materials of different assembly lines cannot be shared. A safe stocking quantity is prepared for each material. When any material is stored below its safe stocking quantity, the warehouse management system automatically replenishes the materials. This material replenishment procedure is called the back flush operation, as described in FIG. 6:

First, when moving material, the ID on the material carton is scanned (step 600). From the scanning result, the system automatically deducts the quantity of the materials (step 610). The system then checks whether the quantity inside the PW is below the safe stocking quantity (step 620). If it is lower than the safe stocking quantity, then a location transfer request list is generated and given to a KC for picking materials (step 630). The picked materials are put into material cartons and transferred to the PW locators (step 640). If the quantity of the material is not lower than the safe stocking quantity, step 650 follows directly. After a product is finished, its ID is scanned (step 650). The materials in the product are deducted from the inventory and transferred to the product (step 660). The location transfer request list generation cycle time is set by the warehouse management system.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A WIP (Work In Progress) management warehouse for controlling areas of different attributes, whose control operation comprises the steps of:
establishing a stocking area, a picking area and a WIP management area;
transferring materials in the stocking area to the picking area according to a WO (Work Order) for material picking;
transferring materials in the picking area to the WIP management area according to a KO (Kit Order) for production; and
returning unused materials to the picking area.

2. The system of claim 1, wherein the stocking area is divided into a plurality of different areas for storing materials.

3. The system of claim 2, wherein the division is made according to characters and sizes of materials.

4. The system of claim 1, wherein the picking is divided into a plurality of different KC's (Kitting Center) for storing materials on the KO.

5. The system of claim 4, wherein the division is made according to usage rates of the materials.

6. The system of claim 1, wherein the WIP management area is divided into a plurality of different assembly lines.

7. The system of claim 6, wherein the division is made according to product types.

8. The system of claim 1, wherein the materials transferred from the stocking area to the picking area are committed materials by the warehouse management system.

9. The system of claim 1, wherein the materials transferred from the picking area to the WIP management area are performed according to usage rates of the materials in the picking area and the material usage rates are set by the warehouse management system.

10. The system of claim 9, wherein through the WO the KC with a higher usage rate achieves the condition of not distributing materials to the WIP management area until all materials needed in the WO are ready.

11. The system of claim 9, wherein the KC with a lower usage rate first uses left-over materials, and opens a material carton and breaks materials therein into components to use.

12. The system of claim 1, wherein the step of returning unused materials to the picking area further comprises the step of determining to which picking area specific unused materials are returned according to material usage rates and the material usage rates are set by the warehouse management system.

13. The system of claim 12, wherein the step of determining to which picking area specific unused materials are returned according to material usage rates further comprises the step of returning unused materials to a high usage rate KC and a low usage rate KC and checking the unused materials periodically according to a time set by the WIP management system.

14. The system of claim 13, wherein the step of returning unused materials to a high usage rate KC and checking the unused materials periodically according to a time set by the WIP management system further comprises the steps of:
picking a low usage rate material and putting it back to the stocking area; and
picking a high usage rate material and transferring it to the WIP management area for further uses.

15. The system of claim 13, wherein the step of returning unused materials to a low usage rate KC and checking the unused materials periodically according to a time set by the WIP management system further comprises the steps of:
picking a low usage rate material, converting it into a dead material, and dumping it to an OBS (Obsolescence); and
picking a high usage rate material and keeping it in the low usage rate KC for further uses and productions.

16. The system of claim 1, wherein the WIP management system provides a SR (Strong Room) for storing expensive materials.

17. The system of claim 16, wherein the SR has an operation procedure comprising the steps of:
generating a PL (Picking List) of the SR through the warehouse management system and performing material picking;
putting picked materials in the SR; and
transferring the picked materials to an assembly line for productions.

18. The system of claim 13, wherein the WIP management system performs data transmissions by using an RF (Radio Frequency) device to read BC's (Bar Code).

19. A WIP management warehouse system, which provides a back flush operation that automatically replenishes materials when the material quantity is lower than a safe stocking quantity through the control of a warehouse management system over a PW (Product Warehouse), the back flush operation comprising the steps of:
moving a material and scanning the BC of the material;
deducting the total quantity of the material from the PW directly;
comparing the quantity of materials stored in the PW with the safe stocking quantity and notifying the warehouse management system if the quantity of materials is lower than the safe stocking quantity;
generating and sending a location transfer request list by the warehouse management system to a KC for picking materials; and
automatically replenishing materials to locators in the PW according to the location transfer request list.

20. The system of claim 19, wherein the PW has different locators for different assembly lines so that materials for different assembly lines cannot be shared.

21. The system of claim 19, wherein the safe stocking quantity is set according to usage rates of materials.

22. The system of claim 19, wherein the generation cycle time for the location transfer request list is set by the warehouse management system.

23. The system of claim 19, wherein the back flush operation performs data transmissions by using an RF (Radio Frequency) device to read BC's.
